(19) United States
(12) Patent Application Publication
(10) Pub. No.: US 2013/0114691 A1
(43) Pub. Date: May 9, 2013

(54) ADAPTIVE INITIALIZATION FOR CONTEXT ADAPTIVE ENTROPY CODING

(71) Applicant: Qualcomm Incorporated, San Diego, CA (US)

(72) Inventors: Liwei Guo, San Diego, CA (US); Marta Karczewicz, San Diego, CA (US); Xianglin Wang, San Diego, CA (US)

(73) Assignee: Qualcomm Incorporated, San Diego, CA (US)

(21) Appl. No.: 13/665,403

(22) Filed: Oct. 31, 2012

Related U.S. Application Data
(60) Provisional application No. 61/555,465, filed on Nov. 3, 2011.

(51) Int. Cl. H04N 7/26

(52) U.S. Cl. 375/240.03; 375/240.02; 375/E07.139; 375/E07.144

(57) ABSTRACT

In one example, an apparatus for context adaptive entropy coding a video unit comprises a coder configured to code a syntax element, wherein a first value of the syntax element indicates that one or more of a plurality of context states are initialized using an adaptive initialization mode for the video unit, and a second value of the syntax element indicates that each of the plurality of context states is initialized using a default initialization mode for the video unit. In some examples, when the syntax element has the first value, the coder is further configured to code a map that indicates which of the context states are initialized using the adaptive initialization mode, and to further code either an initial state value for those contexts, or information from which the initial state values of those adaptively initialized context may be derived.

This application claims the benefit of U.S. Provisional Application Ser. No. 61/555,465, filed Nov. 3, 2011, the entire content of which is incorporated herein by reference.

### TECHNICAL FIELD

This disclosure relates to entropy coding of video data or the like and, more particularly, to context adaptive entropy coding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards. The video devices may transmit, receive, encode, decode, and/or store digital video information more efficiently by implementing such video compression techniques.

Video compression techniques perform spatial (intra-picture) prediction and/or temporal (inter-picture) prediction to reduce or remove redundancy inherent in video sequences. For block-based video coding, a video slice (i.e., a video frame or a portion of a video frame) is partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to a reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data is transformed from the pixel domain to a transform domain, resulting in residual transform coefficients, which then may be quantized. The quantized transform coefficients, initially arranged in a two-dimensional array, are scanned in order to produce a one-dimensional vector of transform coefficients, and entropy coding is applied to achieve even more compression.

### SUMMARY

This disclosure describes techniques for coding data, such as video data. For example, the techniques may be used to code video data, such as residual transform coefficients and/or other syntax elements, generated by video coding processes. In particular, the disclosure describes techniques that may promote efficient coding of video data using context adaptive entropy coding processes, such as context-adaptive binary arithmetic coding (CABAC). The disclosure describes video coding for purposes of illustration only. As such, the techniques described in this disclosure may be applicable to coding other types of data.

In some examples, context adaptive entropy coding a video unit, such as a frame or slice of video data, comprises a coding a syntax element that indicates whether or not an adaptive initialization mode is used to initialize any of the plurality of context states for the video unit. A first value of the syntax element indicates that one or more of a plurality of context states are initialized using an adaptive initialization mode for the video unit, while a second value of the syntax element indicates that each of the plurality of context states is initialized using a default initialization mode for the video unit. When the syntax element has the first value for the video unit, some examples further include coding a map that indicates which of the plurality of context states are initialized using the adaptive initialization mode, and coding either an initial value for those context states, or information from which the initial values of those adaptively initialized context states may be derived.

The techniques of this disclosure may improve compression of the data by enabling the coding system or device to adaptively initialize one or more context states of the context adaptive entropy coding process, e.g., with values different than the default initial values for the contexts such that the contexts include relatively more accurate initial probabilities compared to initial probabilities determined using the default initialization mode. Furthermore, the use of the map to indicate which of a plurality of context states should be initialized using the adaptive initialization mode may allow the adaptive initialization process to be used selectively, on a context-by-context basis, e.g., based upon whether compression gains through adaptive initialization outweigh any increased overhead associated with implementing adaptive initialization relative to default initialization. Additionally, the use of a syntax element to indicate whether any adaptive initialization of context states occurs for a video unit, e.g., frame or slice, may allow adaptive initialization to be used selectively on a per-video unit basis. The syntax element may allow overhead associated with adaptive initialization, e.g., generating, signaling, and processing the map of context states, to be reduced for video units for which adaptive initialization may not provide sufficient compression gains.

In one example, a method for context adaptive entropy coding a video unit comprises coding a syntax element, wherein a first value of the syntax element indicates that one or more of a plurality of context states are initialized using an adaptive initialization mode for the video unit, and a second value of the syntax element indicates that each of the plurality of context states is initialized using a default initialization mode for the video unit. The method further comprises applying the adaptive initialization mode to initialize one or more of the context states when the syntax element is coded with the first value, applying the default initialization mode to initialize all of the contexts when the syntax element is coded with the second value, and context adaptive entropy coding the video unit according to the initialized context states.

In another example, an apparatus for context adaptive entropy coding a video unit comprises a coder configured to code a syntax element, wherein a first value of the syntax element indicates that one or more of a plurality of context states are initialized using an adaptive initialization mode for the video unit, and a second value of the syntax element indicates that each of the plurality of context states is initialized using a default initialization mode for the video unit. The coder is further configured to apply the adaptive initialization mode to initialize one or more of the context states when the syntax element is coded with the first value, apply the default initialization mode to initialize all of the contexts when the syntax element is coded with the second value, and context adaptive entropy code the video unit according to the initialized context states.

In another example, an apparatus for context adaptive entropy coding a video unit comprises means for coding a syntax element, wherein a first value of the syntax element indicates that one or more of a plurality of context states are initialized using an adaptive initialization mode for the video unit, and a second value of the syntax element indicates that each of the plurality of context states is initialized using a default initialization mode for the video unit. The apparatus further comprises means for applying the adaptive initialization mode to initialize one or more of the context states when the syntax element is coded with the first value, means for applying the default initialization mode to initialize all of the contexts when the syntax element is coded with the second value, and means for context adaptive entropy coding the video unit according to the initialized context states.

In another example, a computer-readable storage medium has stored thereon instructions that upon execution cause one or more processors to perform context adaptive entropy coding of a video unit, wherein the instructions cause the one or more processors to code a syntax element, wherein a first value of the syntax element indicates that one or more of a plurality of context states are initialized using an adaptive initialization mode for the video unit, and a second value of the syntax element indicates that each of the plurality of context states is initialized using a default initialization mode for the video unit. The instructions further cause the one or more processors to apply the adaptive initialization mode to initialize one or more of the context states when the syntax element is coded with the first value, apply the default initialization mode to initialize all of the contexts when the syntax element is coded with the second value; and context adaptive entropy code the video unit according to the initialized context states.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram that illustrates an example of a video encoding and decoding system that adaptively initializes context states for context adaptive entropy coding, consistent with the techniques of this disclosure.

FIG. 2 is a block diagram that illustrates an example of a video encoder that adaptively initializes context states for context adaptive entropy coding, consistent with the techniques of this disclosure.

FIG. 3 is a block diagram that illustrates an example of a video decoder that adaptively initializes context states for context adaptive entropy coding, consistent with the techniques of this disclosure

FIGS. 4-8 are flowcharts illustrating example methods for adaptive initialization of context states for context adaptive entropy coding, consistent with the techniques of this disclosure.

### DETAILED DESCRIPTION

In a typical video encoder, the frame (or picture) of an original video sequence is partitioned into rectangular regions or blocks, which are encoded in intra-mode (I-mode) or inter-mode (P-mode). Intra-mode or inter-mode coding produces residual blocks, i.e., blocks of residual data. The residual data in the residual blocks are transformed from a spatial domain to a transform domain such as, e.g., a frequency domain, using some kind of transform, such as a discrete cosine transform (DCT). However, pure transform-based coding only reduces the inter-pixel correlation within a particular block, without considering the inter-block correlation of pixels, and still tends to produce high bit-rates for transmission. Current digital image coding standards also exploit certain methods that reduce the correlation of pixel values between blocks.

In general, blocks encoded in P-mode are predicted from one of the previously coded and transmitted frames. The prediction information of an inter-coded block is represented, in part, by a two-dimensional (2D) motion vector. For the blocks encoded in I-mode, the predicted block is formed using spatial prediction from already encoded neighboring blocks within the same frame. In intra-coding or inter-coding, the prediction error, i.e., the residual difference between the block being encoded and the predicted block, is represented as pixel difference values. Upon transformation, the pixel difference values are represented by transform coefficients applied to a set of weighted basis functions of some discrete transform such as, e.g., a DCT.

The transform is typically performed on an N×N block basis. The weights, i.e., transform coefficients, are subsequently quantized. Quantization introduces loss of information and, therefore, quantized coefficients have lower precision than the original coefficients. Quantized transform coefficients, together with information identifying the predicted block and some control information, form a complete coded sequence representation, and are entropy encoded prior to transmission from the encoder to the decoder so as to further reduce the number of bits needed for their representation.

In the decoder, the block in the current frame is obtained by first constructing its prediction in the same manner as in the encoder, e.g., by entropy decoding the coded sequence representation, and by adding the compressed prediction error to the predicted block. The compressed prediction error is found by inverse quantization and inverse transformation, e.g., weighting the transform basis functions using the quantized coefficients to reproduce the pixel difference values. The difference between the reconstructed frame and the original frame may be referred to as reconstruction error.

Arithmetic coding is a form of entropy coding, i.e., entropy encoding or decoding, found in many compression algorithms that have high coding efficiency, since it can map symbols to non-integer length codewords. An example of an arithmetic coding algorithm is Context Adaptive Binary Arithmetic Coding (CABAC), which is presently used in the H.264/AVC coder, and proposed for use in coders complying with the next-generation high efficiency video coding (HEVC) standard currently under development.

In general, as will be described in greater detail below, a CABAC process includes binarization of symbols to bins having values of 0 or 1, assigning a context to one or more of the bins, and then binary arithmetic encoding the bins using the selected context in a CABAC coding engine. Some of the bins may be encoded using bypass coding, which does not rely on the CABAC coding engine. To encode the bin, an initial state of the context for the bin, i.e., an initial probability value indicating the estimated probability that the values in the bin are 0 or 1, is provided. The context state, i.e., probability value, is then updated based on the actual values (0's or 1's) in the bin as the CABAC process continues.

The efficiency of entropy coding, e.g., according to a CABAC process, may depend on the accuracy of the initial values (probability estimates) of the context states. According to the H.264/AVC standard, and as contemplated for the HEVC standard under development, the initial value of a context for a CABAC entropy coding process is determined according to a default initialization mode for all video units, e.g., slices or frames. However, the actual probability for a particular context may, in practice, be quite different for different sequences, frames, or coding conditions.

The techniques of this disclosure include adaptively initializing the states, i.e., probabilities, of contexts used to code video data in a context adaptive entropy coding process, such as, for example, a CABAC process. For example, the state of a context may be initialized using a default initialization mode or an adaptive initialization mode, on a selective basis.

In the default initialization mode, in some examples, a video coder, as either a video encoder or a video decoder, assigns pre-defined initial state values to the contexts for each video unit, e.g., by computation of the initial state values using predefined parameter values. The adaptive initialization mode may adaptively set initial context state values for a video unit. A video unit may be a frame or slice, or other video units such as coding units, entropy slices, tiles, or sequences of frames. In some examples, an adaptive initialization mode for adaptively setting context states may promote enhanced coding performance.

The adaptive initialization mode may be used for all contexts, or for individual contexts on a selective basis. Hence, some contexts may be initialized using the default mode and other contexts may be initialized using the adaptive mode. There may be a large set of contexts, in some examples, with different contexts associated with different syntax elements.

Furthermore, whether the state for a particular context is initialized using the default or adaptive initialization mode may be selectively determined for different frames, slices, or other video units. In some examples, a syntax element, such as a flag, may be used to signal whether default or adaptive initialization is used for any of the contexts of a frame, slice or other video unit.

If adaptive initialization is used on a selective basis for individual contexts, a map may be used to indicate initialization status of each individual context, in terms of whether the default or adaptive initialization mode is used for each individual context. When the adaptive initialization mode is used for a context state, actual initial context initialization state values may be explicitly signaled, or a decoder may derive the initial context state values using other information signaled by the encoder.

In this disclosure, the term “coding” refers to encoding that occurs at an encoder or decoding that occurs at a decoder. Similarly, the term “coder” refers to an encoder, a decoder, or a combined encoder/decoder (e.g., “CODEC”). The terms coder, encoder, decoder, and CODEC all refer to specific machines designed for the coding (i.e., encoding and/or decoding) of data, such as, video data, consistent with this disclosure.

Such a method for adaptive initialization may be useful, for example, in a context adaptive binary arithmetic coding (CABAC) process, and particularly useful in a video encoder or video decoder that employs CABAC for entropy coding of transform coefficients, motion vectors and other syntax elements. The techniques of this disclosure may, in some examples, be used with any context adaptive entropy coding methodology, including context adaptive variable length coding (CAVLC), CABAC, syntax-based context-adaptive binary arithmetic coding (SBAC), Probability Interval Partitioning Entropy (PIPE) coding, or another context adaptive entropy coding methodology. CABAC is described herein for purposes of illustration only, and without limitation as to the techniques broadly described in this disclosure. Also, the techniques described herein may be applied to coding of other types of data generally, e.g., in addition to video data.

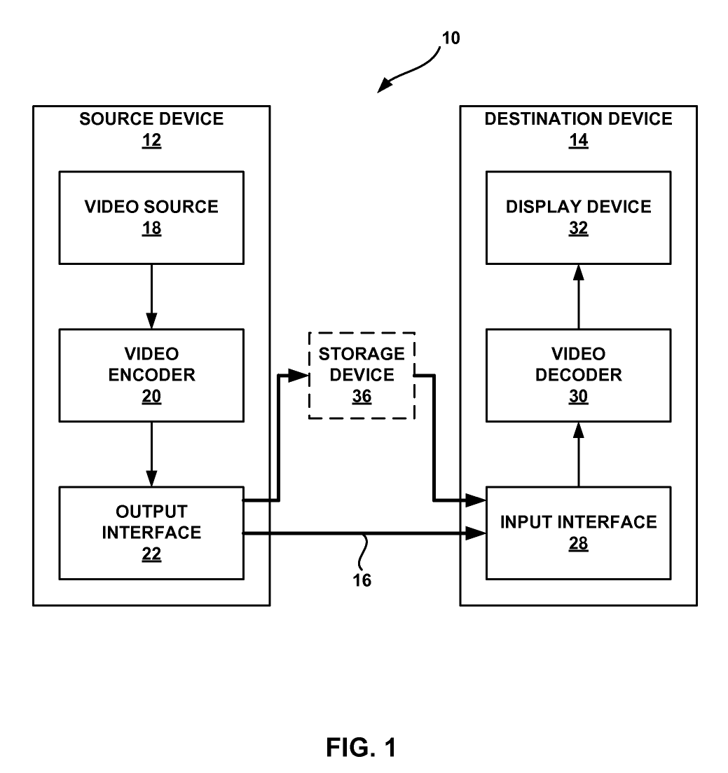

FIG. 1 is a block diagram that illustrates an example of a video encoding and decoding system 10 that may adaptively initialize context states for context adaptive entropy coding, consistent with the techniques of this disclosure. As shown in FIG. 1, system 10 includes a source device 12 that generates encoded video data to be decoded at a later time by a destination device 14. Source device 12 and destination device 14 may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

Destination device 14 may receive the encoded video data to be decoded via a link 16. Link 16 may comprise any type of medium or device capable of moving the encoded video data from source device 12 to destination device 14. In one example, link 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

In other examples, encoded data may be output from output interface 22 to a storage device 36. Similarly, encoded data may be accessed from storage device 36 by input interface 28. Storage device 36 may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, storage device 36 may correspond to a file server or another intermediate storage device that may hold the encoded video generated by source device 12. Destination device 14 may access stored video data from storage device 36 via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from storage device 36 may be a streaming transmission, a download transmission, or a combination of both.

The techniques of this disclosure are not necessarily limited to wireless applications or settings. The techniques may be applied to video coding in support of any of a variety of multimedia applications, such as over-the-air television broadcasts, cable television transmissions, satellite television transmissions, streaming video transmissions, e.g., via the Internet, encoding of digital video for storage on a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes a video source 18, video encoder 20 and an output interface 22. In some cases, output interface 22 may include a modulator/demodulator (modem) and/or a transmitter. In source device 12, video source 18 may include a source such as a video capture device, e.g., a video camera, a video archive containing previously captured video, a video feed interface to receive video from a video content provider, and/or a computer graphics system for generating computer graphics data as the source video, or a combination of such sources. As one example, if video source 18 is a video camera, source device 12 and destination device 14 may form so-called camera phones or video phones. However, the techniques described in this disclosure may be applicable to video coding in general, and may be applied to wireless and/or wired applications.

The captured, pre-captured, or computer-generated video may be encoded by video encoder 12. The encoded video data may be transmitted directly to destination device 14 via output interface 22 of source device 20 and link 16. The encoded video data may also (or alternatively) be stored onto storage device 36 for later access by destination device 14 or other devices, for decoding and/or playback.

Destination device 14 includes an input interface 28, a video decoder 30, and a display device 32. In some cases, input interface 28 may include a receiver and/or a modem. Input interface 28 of destination device 14 may receive the encoded video data over link 16, or from storage device 36. The encoded video data communicated over link 16, or provided on storage device 36, may include a variety of syntax elements generated by video encoder 20 for use by a video decoder, such as video decoder 30, in decoding the video data. Such syntax elements may be included with the encoded video data transmitted on a communication medium, stored on a storage medium, or stored a file server.

Display device 32 may be integrated with, or external to, destination device 14. In some examples, destination device 14 may include an integrated display device and also be configured to interface with an external display device. In other examples, destination device 14 may be a display device. In general, display device 32 displays the decoded video data to a user, and may comprise any of a variety of display devices such as a liquid crystal display (LCD), a plasma display, an organic light emitting diode (OLED) display, or another type of display device.

Video encoder 20 and video decoder 30 may operate according to a video compression standard, such as the High Efficiency Video Coding (HEVC) standard presently under development, and may conform to the HEVC Test Model (HM). Alternatively, video encoder 20 and video decoder 30 may operate according to other proprietary or industry standards, such as the ITU-T H.264 standard, alternatively referred to as MPEG-4, Part 10, Advanced Video Coding (AVC), or extensions of such standards. The techniques of this disclosure, however, are not limited to any particular coding standard. Other examples of video compression standards include MPEG-2 and ITU-T H.263. A recent draft of the HEVC standard, referred to as “HEVC Working Draft 8” or “WD8,” is described in document JCTVC-J1003_d7, Bross et al., “High efficiency video coding (HEVC) text specification draft 8,” Joint Collaborative Team on Video Coding (JCT-VC) of ITU-T SG16 WP3 and ISO/IEC JTC1/SC29/WG11, 10th Meeting: Stockholm, SE, 11-20 Jul., 2012.

Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, in some examples, MUX-DEMUX units may conform to the ITU H.223 multiplexer protocol, or other protocols such as the user datagram protocol (UDP).

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device.

The HEVC standardization efforts are based on an evolving model of a video coding device referred to as the HEVC Test Model (HM). The HM presumes several additional capabilities of video coding devices relative to existing devices according to, e.g., ITU-T H.264/AVC. For example, whereas H.264 provides nine intra-prediction encoding modes, the HM may provide as many as thirty-five intra-prediction encoding modes.

In general, the working model of the HM describes that a video frame or picture may be divided into a sequence of treeblocks or largest coding units (LCU) that include both luma and chroma samples. A treeblock has a similar purpose as a macroblock of the H.264 standard. A slice includes a number of consecutive treeblocks in coding order. A video frame or picture may be partitioned into one or more slices. Each treeblock may be split into coding units (CUs) according to a quadtree. For example, a treeblock, as a root node of the quadtree, may be split into four child nodes, and each child node may in turn be a parent node and be split into another four child nodes. A final, unsplit child node, as a leaf node of the quadtree, comprises a coding node, i.e., a coded video block. Syntax data associated with a coded bitstream may define a maximum number of times a treeblock may be split, and may also define a minimum size of the coding nodes.

A CU includes a coding node and prediction units (PUs) and transform units (TUs) associated with the coding node. A size of the CU corresponds to a size of the coding node and must be square in shape. The size of the CU may range from 8×8 pixels up to the size of the treeblock with a maximum of 64×64 pixels or greater. Each CU may contain one or more PUs and one or more TUs. Syntax data associated with a CU may describe, for example, partitioning of the CU into one or more PUs. Partitioning modes may differ between whether the CU is skip or direct mode encoded, intra-prediction mode encoded, or inter-prediction mode encoded. PUs may be partitioned to be non-square in shape. Syntax data associated with a CU may also describe, for example, partitioning of the CU into one or more TUs according to a quadtree. A TU can be square or non-square in shape.

The HEVC standard allows for transformations according to TUs, which may be different for different CUs. The TUs are typically sized based on the size of PUs within a given CU defined for a partitioned LCU, although this may not always be the case. The TUs are typically the same size or smaller than the PUs. In some examples, residual samples corresponding to a CU may be subdivided into smaller units using a quadtree structure known as “residual quad tree” (RQT). The leaf nodes of the RQT may be referred to as transform units (TUs). Pixel difference values associated with the TUs may be transformed to produce transform coefficients, which may be quantized.

In general, a PU includes data related to the prediction process. For example, when the PU is intra-mode encoded, the PU may include data describing an intra-prediction mode for the PU. As another example, when the PU is inter-mode encoded, the PU may include data defining a motion vector for the PU. The data defining the motion vector for a PU may describe, for example, a horizontal component of the motion vector, a vertical component of the motion vector, a resolution for the motion vector (e.g., one-quarter pixel precision or one-eighth pixel precision), a reference picture to which the motion vector points, and/or a reference picture list (e.g., List 0, List 1, or List C) for the motion vector.

In general, a TU is used for the transform and quantization processes. A given CU having one or more PUs may also include one or more transform units (TUs). Following prediction, video encoder 20 may calculate residual values corresponding to the PU. The residual values comprise pixel difference values that may be transformed into transform coefficients, quantized, and scanned using the TUs to produce serialized transform coefficients for entropy coding. This disclosure typically uses the term “video block” to refer to a coding node of a CU. In some specific cases, this disclosure may also use the term “video block” to refer to a treeblock, i.e., LCU, or a CU, which includes a coding node and PUs and TUs.

A video sequence typically includes a series of video frames or pictures. A group of pictures (GOP) generally comprises a series of one or more of the video pictures. A GOP may include syntax data in a header of the GOP, a header of one or more of the pictures, or elsewhere, that describes a number of pictures included in the GOP. Each slice of a picture may include slice syntax data that describes an encoding mode for the respective slice. Video encoder 20 typically operates on video blocks within individual video slices in order to encode the video data. A video block may correspond to a coding node within a CU. The video blocks may have fixed or varying sizes, and may differ in size according to a specified coding standard.

As an example, the HM supports prediction in various PU sizes. Assuming that the size of a particular CU is 2N×2N, the HM supports intra-prediction in PU sizes of 2N×2N or N×N, and inter-prediction in symmetric PU sizes of 2N×2N, 2N×N, N×2N, or N×N. The HM also supports asymmetric partitioning for inter-prediction in PU sizes of 2N×nU, 2N×nD, nL×2N, and nR×2N. In asymmetric partitioning, one direction of a CU is not partitioned, while the other direction is partitioned into 25% and 75%. The portion of the CU corresponding to the 25% partition is indicated by an “n” followed by an indication of “Up”, “Down,” “Left,” or “Right.” Thus, for example, “2N×nU” refers to a 2N×2N CU that is partitioned horizontally with a 2N×0.5N PU on top and a 2N×1.5N PU on bottom.

In this disclosure, “N×N” and “N by N” may be used interchangeably to refer to the pixel dimensions of a video block in terms of vertical and horizontal dimensions, e.g., 16×16 pixels or 16 by 16 pixels. In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N.

Following intra-predictive or inter-predictive coding using the PUs of a CU, video encoder 20 may calculate residual data for the TUs of the CU. The PUs may comprise pixel data in the spatial domain (also referred to as the pixel domain) and the TUs may comprise coefficients in the transform domain following application of a transform, e.g., a discrete cosine transform (DCT), an integer transform, a wavelet transform, or a conceptually similar transform to residual video data. The residual data may correspond to pixel differences between pixels of the unencoded picture and prediction values corresponding to the PUs. Video encoder 20 may form the TUs including the residual data for the CU, and then transform the TUs to produce transform coefficients for the CU.

Following any transforms to produce transform coefficients, video encoder 20 may perform quantization of the transform coefficients. Quantization generally refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m.

In some examples, video encoder 20 may utilize a predefined scan order to scan the quantized transform coefficients to produce a serialized vector that can be entropy encoded. The predefined scanning orders may vary based on factors such as the coding mode or transform size or shape used in the coding process. Furthermore, in other examples, video encoder 20 may perform an adaptive scan, e.g., using a scanning order that is periodically adapted. The scanning order may adapt differently for different blocks, e.g., based on the coding mode or other factors.

In any case, after scanning the quantized transform coefficients to form the serialized “one-dimensional” vector, video encoder 20 may further entropy encode the one-dimensional vector, e.g., according to CAVLC, CABAC, SBAC, PIPE, or another context adaptive entropy encoding methodology. Techniques in accordance with examples of this disclosure will be described in conjunction with CABAC entropy coding for purposes of illustration. Video encoder 20 may also entropy encode other syntax elements associated with the encoded video data for use by video decoder 30 in decoding the video data.

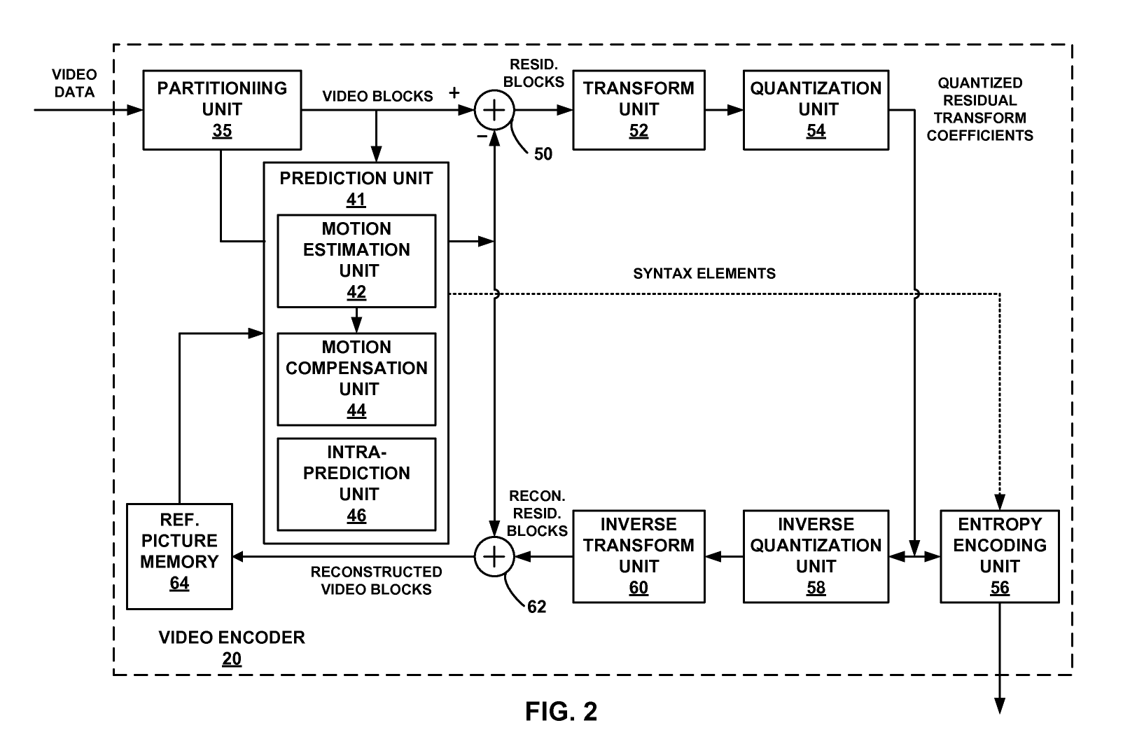

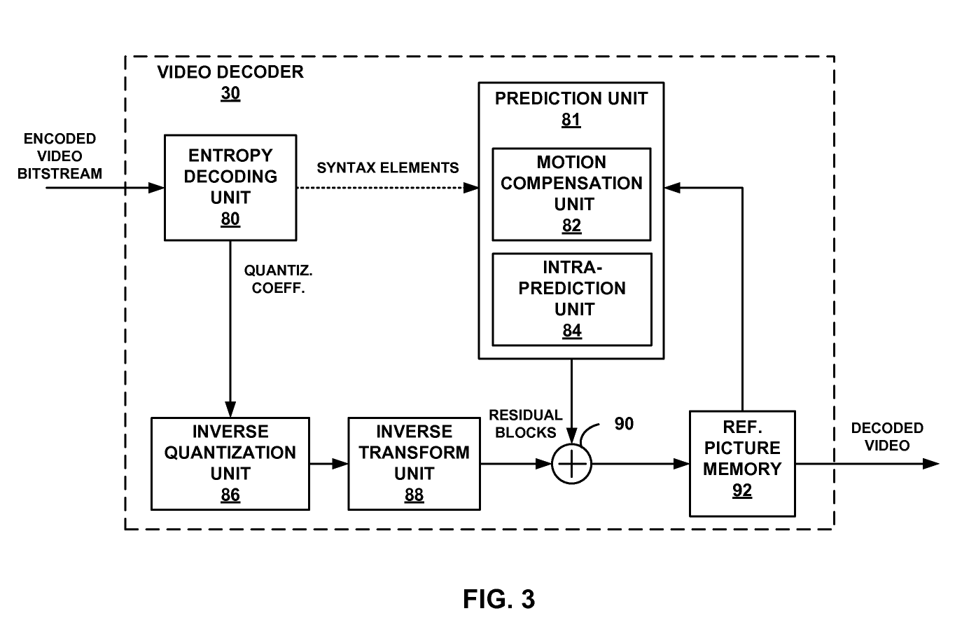

Although video encoding and quantization by video encoder 20 has been described above, video decoder 30 may generally perform an inverse of the quantization and video encoding described above with respect to video encoder 20 in order to decode the video data. Furthermore, video decoder 30 may perform the same or similar context adaptive entropy coding techniques as video encoder 20, to decode the encoded video data and any additional syntax elements associated with the video data. Example functionalities of video encoder 20 and video decoder 30 are described in greater detail below with respect to FIGS. 2 and 3, respectively.

In general, entropy coding (encoding or decoding) any data symbol using CABAC involves the following:

(1) Binarization: If a symbol to be coded is non-binary valued it is mapped to a sequence of so-called bins. Each bin can have a value of 0 or 1.

(2) Context Assignment. Each bin is assigned to a context. A context model determines how context is calculated based on information available for a given bin such as values of previously encoded symbols or bin number.

(3) Bin encoding: Bins are encoded with the arithmetic encoder. To encode a bin, the arithmetic encoder requires as input the initial probability of bin values, i.e., what is the probability that the bin value is equal to 0 and what is the probability that the bin value is equal to 1. The (estimated) probability of each context is represented by an integer value called a context state. Each context has a state and thus the state (i.e., estimated probability) is the same for bins assigned to one context and differs between contexts.

(4) State update: The probability (state) for a selected context is updated based on the actual coded value. For example, if the bin value was “1”, the probability of “1”s is increased.

Many aspects of this disclosure are described specifically in the context of CABAC. Additionally, PIPE, CAVLC, SBAC or other context adaptive entropy coding techniques may use similar principles as those described herein with reference to CABAC. In particular, these or other context adaptive entropy coding techniques may utilize context state initialization, and can therefore also benefit from the techniques of this disclosure.

In a CABAC coding process, at the beginning of each video unit, e.g., frame, slice, or block, an encoder or decoder may initialize each of a plurality context states. In particular, the encoder or decoder may assign initial state values to each context of a plurality of contexts. In HEVC, for example, there are in total approximately 369 contexts for each slice. Different contexts are used for different syntax elements.

In H.264/AVC and certain draft versions of HEVC, a linear relationship, or “model,” is used to assign initial context state values for each context. For each context, there are two pre-defined initialization parameters, slope (“m”) and intersection (“n”), used to determine the initial context state for the context. In a default initialization mode, at the beginning of each slice, the initial state for a context is calculated using predefined values of m and n, and a quantization parameter (QP). For example, in the default initialization mode, the initial context state is calculated according to the following formula:

initial state=m*QP/16+n. EQ. (1)

In the default initialization mode, QP may be set on frame-by-frame, slice-by-slice, block-by-block, or other basis. The terms frame and picture may be used interchangeably in this disclosure. The values of m and n may be pre-defined for each context in the default mode.

Increased accuracy of the estimated probability from the initial context state value may result in greater entropy coding efficiency. However, the probability for the bin of the same syntax can be quite different for different sequences, frames, and coding conditions. Consequently, initial context state values, i.e., initial probability values, determined based on the default initialization mode, e.g., as described above, may not provide desired coding efficiency in all cases.

According to the techniques of this disclosure, video encoder 20 and/or video decoder 30 use an adaptive initialization mode to provide adaptive initial state values (initial probabilities) for one or more contexts, e.g., when initial state values for contexts determined using the default initialization mode have not provided desired coding efficiency. In some examples, encoder 20 and/or decoder 30 determine whether the initial value (i.e., initial context state) of a context is determined according to the adaptive or default initialization mode for each frame, slice, or other video unit (e.g., entropy slices or tiles). In some examples, the techniques of this disclosure may allow encoder 20 and/or decoder 30 to adaptively generate different initial state values for a particular context on a selective basis for different frames, slices, or other video units. In this manner, encoder 20 and/or decoder 30 may adjust the initial probabilities for the contexts for different sequences, frames, slices, video units, and/or coding conditions.

In some examples, encoder 20 and/or decoder 30 may selectively initialize all of the context states (e.g., among approximately 369 contexts in HEVC) according to either the default initialization mode or the adaptive initialization mode. In other examples, encoder 20 and/or decoder 30 may selectively initialize individual context states, among the plurality of contexts, according to either the default initialization mode or the adaptive initialization mode. In general, the default initialization mode is a first initialization mode and the adaptive initialization mode is a second initialization mode that is different from the first initialization mode. In some examples, the first and second modes may be different, in one or more ways, such as in terms of the manner in which the context states are initialized, e.g., using pre-defined initialization parameters and a pre-defined formula for the first mode, and using adaptive, selectable initialization values or parameters in the second mode.

In some examples, when the adaptive initialization mode is used, probability estimates included within the context model are more accurate relative to probability estimates determined using other techniques. Hence, encoder 20 and/or decoder 30 may code residual transform coefficients and other elements of the coded sequence more efficiently, e.g., using fewer bits.

FIG. 2 is a block diagram that illustrates an example of a video encoder 20 that may adaptively initialize context states for context adaptive entropy coding, consistent with the techniques of this disclosure. Video encoder 20 may perform intra- and inter-coding of video blocks within video slices. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based compression modes. Inter-modes, such as uni-directional prediction (P mode) or bi-prediction (B mode), may refer to any of several temporal-based compression modes.

In the example of FIG. 2, video encoder 20 includes a partitioning unit 35, prediction processing unit 41, reference picture memory 64, summer 50, transform processing unit 52, quantization unit 54, and entropy encoding unit 56. Prediction processing unit 41 includes motion estimation unit 42, motion compensation unit 44, and intra-prediction unit 46. For video block reconstruction, video encoder 20 also includes inverse quantization unit 58, inverse transform unit 60, and summer 62. A deblocking filter (not shown in FIG. 2) may also be included to filter block boundaries to remove blockiness artifacts from reconstructed video. If desired, the deblocking filter would typically filter the output of summer 62. Additional loop filters (in loop or post loop) may also be used in addition to the deblocking filter.

As shown in FIG. 2, video encoder 20 receives video data, and partitioning unit 35 partitions the data into video blocks. This partitioning may also include partitioning into slices, tiles, or other larger units, as wells as video block partitioning, e.g., according to a quadtree structure of LCUs and CUs. Video encoder 20 generally illustrates the components that encode video blocks within a video slice to be encoded. The slice may be divided into multiple video blocks (and possibly into sets of video blocks referred to as tiles). Prediction processing unit 41 may select one of a plurality of possible coding modes, such as one of a plurality of intra-coding modes or one of a plurality of inter-coding modes, for the current video block based on error results (e.g., coding rate and the level of distortion). Prediction processing unit 41 may provide the resulting intra- or inter-coded block to summer 50 to generate residual block data and to summer 62 to reconstruct the encoded block for use as a reference picture.

Intra-prediction unit 46 within prediction processing unit 41 may perform intra-predictive coding of the current video block relative to one or more neighboring blocks in the same frame or slice as the current block to be coded to provide spatial compression. Motion estimation unit 42 and motion compensation unit 44 within prediction processing unit 41 perform inter-predictive coding of the current video block relative to one or more predictive blocks in one or more reference pictures to provide temporal compression.

Motion estimation unit 42 may be configured to determine the inter-prediction mode for a video slice according to a predetermined pattern for a video sequence. The predetermined pattern may designate video slices in the sequence as P slices, B slices or GPB slices. Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a PU of a video block within a current video frame or picture relative to a predictive block within a reference picture.

A predictive block is a block that is found to closely match the PU of the video block to be coded in terms of pixel difference, which may be determined by sum of absolute difference (SAD), sum of square difference (SSD), or other difference metrics. In some examples, video encoder 20 may calculate values for sub-integer pixel positions of reference pictures stored in reference picture memory 64. For example, video encoder 20 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in reference picture memory 64. Motion estimation unit 42 sends the calculated motion vector, along with the prediction direction and reference picture value, to entropy encoding unit 56 and motion compensation unit 44.

Motion compensation, performed by motion compensation unit 44, may involve fetching or generating the predictive block based on the motion vector determined by motion estimation, possibly performing interpolations to sub-pixel precision. Upon receiving the motion vector for the PU of the current video block, motion compensation unit 44 may locate the predictive block to which the motion vector points in one of the reference picture lists. Video encoder 20 forms a residual video block by subtracting pixel values of the predictive block from the pixel values of the current video block being coded, forming pixel difference values. The pixel difference values form residual data for the block, and may include both luma and chroma difference components. Summer 50 represents the component or components that perform this subtraction operation. Motion compensation unit 44 may also generate syntax elements associated with the video blocks and the video slice for use by video decoder 30 in decoding the video blocks of the video slice.

Intra-prediction unit 46 may intra-predict a current block, as an alternative to the inter-prediction performed by motion estimation unit 42 and motion compensation unit 44, as described above. In particular, intra-prediction unit 46 may determine an intra-prediction mode to use to encode a current block. In some examples, intra-prediction unit 46 may encode a current block using various intra-prediction modes, e.g., during separate encoding passes, and intra-prediction unit 46 may select an appropriate intra-prediction mode to use from the tested modes. For example, intra-prediction unit 46 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bit rate (that is, a number of bits) used to produce the encoded block. Intra-prediction unit 46 may calculate ratios from the distortions and rates for the various encoded blocks to determine which intra-prediction mode exhibits the best rate-distortion value for the block.

In any case, after selecting an intra-prediction mode for a block, intra-prediction unit 46 may provide information indicative of the selected intra-prediction mode for the block to entropy coding unit 56. Entropy coding unit 56 may encode the information indicating the selected intra-prediction mode in accordance with the techniques of this disclosure. Video encoder 20 may include in the transmitted bitstream configuration data, which may include a plurality of intra-prediction mode index tables and a plurality of modified intra-prediction mode index tables (also referred to as codeword mapping tables), definitions of encoding contexts for various blocks, and indications of a most probable intra-prediction mode, an intra-prediction mode index table, and a modified intra-prediction mode index table to use for each of the contexts.

After prediction processing unit 41 generates the predictive block for the current video block via either inter-prediction or intra-prediction, video encoder 20 forms a residual video block by subtracting the predictive block from the current video block. The residual video data in the residual block may be included in one or more TUs and applied to transform processing unit 52. Transform processing unit 52 transforms the residual video data into residual transform coefficients using a transform, such as a discrete cosine transform (DCT) or a conceptually similar transform. Transform processing unit 52 may convert the residual video data from a pixel domain to a transform domain, such as a frequency domain.

Transform processing unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan.

Following quantization, entropy encoding unit 56 entropy encodes the quantized transform coefficients. For example, entropy encoding unit 56 may perform CAVLC, CABAC, SBAC, PIPE, or another entropy encoding methodology or technique. Following the entropy encoding by entropy encoding unit 56, the encoded bitstream may be transmitted to video decoder 30, or archived for later transmission or retrieval by video decoder 30. Entropy encoding unit 56 may also entropy encode the motion vectors and the other syntax elements for the current video slice being coded.

Inverse quantization unit 58 and inverse transform unit 60 apply inverse quantization and inverse transformation, respectively, to reconstruct the residual block in the pixel domain for later use as a reference block of a reference picture. Motion compensation unit 44 may calculate a reference block by adding the residual block to a predictive block of one of the reference pictures within one of the reference picture lists. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reference block for storage in reference picture memory 64. The reference block may be used by motion estimation unit 42 and motion compensation unit 44 as a reference block to inter-predict a block in a subsequent video frame or picture.

In some examples, an apparatus that includes entropy encoding unit 56 (e.g., video encoder 20 of source device 12 of FIG. 1) may be configured for context adaptive entropy coding. For example, the apparatus may be configured to perform the CABAC process described above, or CAVLC, SBAC, PIPE, or any other context adaptive entropy coding processes. In some examples, the apparatus (e.g., video encoder 20 of source device 12 of FIG. 1) that includes entropy encoding unit 56 may be configured as a video encoder. In these examples, the video encoder may be configured to encode one or more syntax elements associated with a block of video data based on the initialized state values of one or more contexts of the context adaptive entropy coding process, and output the encoded one or more syntax elements in a bitstream. In some examples, as previously described, the apparatus (e.g., video encoder 20 of source device 12 of FIG. 1) that includes entropy encoding unit 56 may include at least one of an integrated circuit, a microprocessor, and a wireless communication device that includes entropy encoding unit 56.

In some examples, entropy encoding unit 56 may be configured to adaptively initialize the states, i.e., probabilities, of contexts used to code video data in a context adaptive entropy coding process, such as, for example, a CABAC process. In some examples, entropy encoding unit 56 may be configured to, on a selective basis, initialize the state of a context using a default initialization mode, or an adaptive initialization mode. Entropy encoding unit 56 may be configured to select whether to initialize a particular context state according to the default or adaptive initialization mode on a per-video unit selective basis, e.g., slice-by-slice, or frame-by-frame, or block-by-block.

For a given video unit, e.g., frame or slice, entropy encoding unit 56 may determine which, if any, context states should be initialized using the adaptive initialization mode. In other words, entropy encoding unit 56 may decide whether to use the default initialization mode or the adaptive initialized mode. Entropy encoding unit 56 may determine whether a context state should be initialized using the adaptive initialization mode for a particular video unit based on whether the initial value of the context state as would be determined according to the default initialization mode will likely provide adequate entropy coding efficiency. Entropy coding unit 56 may make this determination based on whether adaptive initialization will provide increase coding efficiency, e.g., relative to some threshold. In some examples, entropy encoding unit 56 may make this determination by, for example, evaluating a difference between the initial state value of the context as would be determined according to the default initialization mode, and a final state of the context, i.e., final probability value, produced during entropy coding of a similar video unit that was previously entropy encoded.

Entropy encoding unit 56 may encode a syntax element for a video unit, such as a picture, slice, or block, or for a sequence of pictures, that indicates, e.g., to video decoder 30, whether any context states are to be initialized according to the adaptive initialization mode for the video unit. The syntax element may be presented, for example, in a sequence parameter set (SPS), picture parameter set (PPS), adaptation parameter set (APS), slice header, entropy slice header, coding unit (CU) header, or the like. Entropy encoding unit 56 may change a value of the syntax element, e.g., flag, between a first and second value to indicate, e.g., to indicate to video decoder 30 whether any context states are to be initialized according to the adaptive initialization mode for a particular video unit.

If entropy encoding unit 56 determines that one or more context states should be initialized according to the adaptive initialization mode for a given video unit, entropy encoding unit 56 may be configured to encode a map to indicate, e.g., to video decoder 30, initialization status of each individual context, in terms of whether the default or adaptive initialization mode for context state initialization is used for each individual context. Entropy encoding unit 56 may update the map on a per-video unit basis, based upon which context states are initialized according to the default initialization mode and the adaptive initialization mode. If none of the context states are initialized according to the adaptive initialization mode for a given video unit, entropy encoding unit 56 may not encode the map, and may encode the value of the syntax element, e.g., flag, to indicate, e.g., to video decoder 30, that no contexts are to be initialized according to the adaptive initialization mode. In this manner, if no adaptive initialization is needed for a particular video unit, entropy encoding unit 56 may avoid generating, and the bitstream need not include, the map for that video unit.

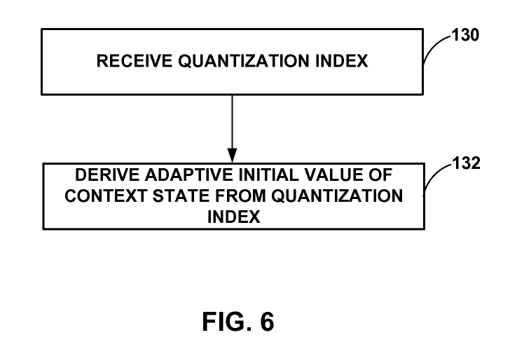

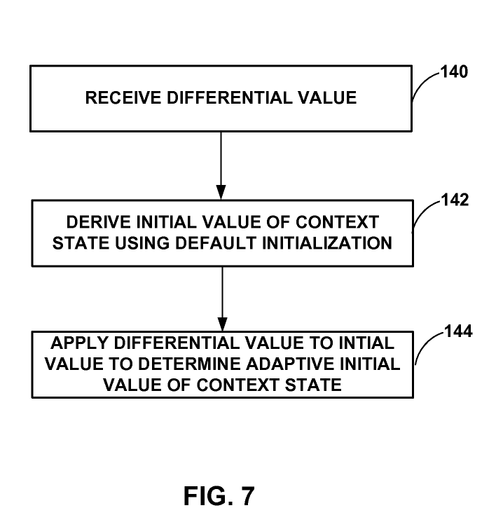

When entropy encoding unit 56 uses the adaptive initialization mode for a context state, entropy encoding unit 56 may, in some examples, explicitly signal the actual initial context state value used for entropy encoding to video decoder 30 for entropy decoding by the video decoder. In other examples, entropy encoding unit 56 may instead signal other information to decoder 30, from which decoder 30 may derive the initial context state value. Examples of signaling other information and deriving the initial context state value are described below with reference to FIGS. 6 and 7.

FIG. 3 is a block diagram that illustrates an example of a video decoder 30 that may adaptively initialize context states for context adaptive entropy coding, consistent with the techniques of this disclosure. In the example of FIG. 3, video decoder 30 includes an entropy decoding unit 80, prediction unit 81, inverse quantization unit 86, inverse transformation unit 88, summer 90, and reference picture memory 92. Prediction unit 81 includes motion compensation unit 82 and intra prediction unit 84. Video decoder 30 may, in some examples, perform a decoding pass generally reciprocal to the encoding pass described with respect to video encoder 20 from FIG. 2.

During the decoding process, video decoder 30 receives an encoded video bitstream that represents video blocks of an encoded video slice and associated syntax elements from video encoder 20, e.g., via medium 16 or server 36. Entropy decoding unit 80 of video decoder 30 entropy decodes the bitstream to generate quantized coefficients, motion vectors, and other syntax elements. Entropy decoding unit 80 forwards the motion vectors and other syntax elements to prediction unit 81. Video decoder 30 may receive the syntax elements at the video slice level and/or the video block level.

When the video slice is coded as an intra-coded (I) slice, intra prediction unit 84 of prediction unit 81 may generate prediction data for a video block of the current video slice based on a signaled intra prediction mode and data from previously decoded blocks of the current frame or picture. When the video frame is coded as an inter-coded (i.e., B, P or GPB) slice, motion compensation unit 82 of prediction unit 81 produces predictive blocks for a video block of the current video slice based on the motion vectors and other syntax elements received from entropy decoding unit 80. The predictive blocks may be produced from one of the reference pictures within one of the reference picture lists. Video decoder 30 may construct the reference frame lists, List 0 and List 1, using default construction techniques based on reference pictures stored in reference picture memory 92.

Motion compensation unit 82 determines prediction information for a video block of the current video slice by parsing the motion vectors and other syntax elements, and uses the prediction information to produce the predictive blocks for the current video block being decoded. For example, motion compensation unit 82 uses some of the received syntax elements to determine a prediction mode (e.g., intra- or inter-prediction) used to code the video blocks of the video slice, an inter-prediction slice type (e.g., B slice, P slice, or GPB slice), construction information for one or more of the reference picture lists for the slice, motion vectors for each inter-encoded video block of the slice, inter-prediction status for each inter-coded video block of the slice, and other information to decode the video blocks in the current video slice.

Motion compensation unit 82 may also perform interpolation based on interpolation filters. Motion compensation unit 82 may use interpolation filters as used by video encoder 20 during encoding of the video blocks to calculate interpolated values for sub-integer pixels of reference blocks. In this case, motion compensation unit 82 may determine the interpolation filters used by video encoder 20 from the received syntax elements and use the interpolation filters to produce predictive blocks.

Inverse quantization unit 86 inverse quantizes, i.e., de-quantizes, the quantized transform coefficients provided in the bitstream and decoded by entropy decoding unit 80. The inverse quantization process may include use of a quantization parameter calculated by video encoder 20 for each video block in the video slice to determine a degree of quantization and, likewise, a degree of inverse quantization that should be applied. Inverse transform unit 88 applies an inverse transform, e.g., an inverse DCT, an inverse integer transform, or a conceptually similar inverse transform process, to the transform coefficients in order to produce residual blocks in the pixel domain.

After prediction unit 81 generates the predictive block for the current video block based on either intra-, or inter-prediction, video decoder 30 forms a decoded video block by summing the residual blocks from inverse transform unit 88 with the corresponding predictive blocks generated by prediction unit 81. Summer 90 represents the component or components that perform this summation operation. If desired, a deblocking filter may also be applied to filter the decoded blocks in order to remove blockiness artifacts. Other loop filters (either in the coding loop or after the coding loop) may also be used to smooth pixel transitions, or otherwise improve the video quality. The decoded video blocks in a given frame or picture are then stored in reference picture memory 92, which stores reference pictures used for subsequent motion compensation. Reference picture memory 92 also stores decoded video for later presentation on a display device, such as display device 32 of FIG. 1.

In some examples, an apparatus that includes entropy decoding unit 80 (e.g., video decoder 30 of destination device 14 of FIG. 1) may be configured for context adaptive entropy coding. For example, the apparatus may be configured to perform the CABAC process described above, or CAVLC, SBAC, PIPE, or any other context adaptive entropy coding processes. In some examples, the apparatus (e.g., video decoder 30 of destination device 14 of FIG. 1) that includes entropy decoding unit 80 may be configured as a video decoder. In these examples, the video decoder may be configured to decode one or more syntax elements associated with a block of video data based on the initialized one or more contexts of the context adaptive entropy coding process, and provide the decoded one or more syntax elements to other elements of the video decoder for video decoding, as described above. In some examples, as previously described, the apparatus (e.g., video decoder 30 of destination device 14 of FIG. 1) that includes entropy decoding unit 80 may include at least one of an integrated circuit, a microprocessor, and a wireless communication device that includes entropy decoding unit 80.

In some examples, entropy decoding unit 80 may be configured to adaptively initialize the states, i.e., probabilities, of contexts used to code video data in a context adaptive entropy coding process, such as, for example, a CABAC process. In some examples, entropy decoding unit 80 is configured to, on a selective basis, initialize the state of a context using a default initialization mode, or an adaptive initialization mode. Entropy decoding unit 80 may be configured to select whether to initialize a particular context state according to the default or adaptive initialization mode on a per-video unit basis, e.g., slice-by-slice, or frame-by-frame.

For a given video unit, e.g., frame or slice, entropy decoding unit 80 may determine which, if any, context states should be initialized using the adaptive initialization mode. Entropy decoding unit 80 may determine whether a context state should be initialized using the default or adaptive initialization mode for a particular video unit based on information received from a video encoder 20. For example, entropy decoding unit 80 may decode a syntax element for a video unit, e.g., provided by video encoder 20, that indicates whether any context states are to be initialized according to the adaptive initialization mode for the video unit. The syntax element may be a flag and, for a given video unit, may have a either a first value that indicates that one or more context states are to be initialized according to the adaptive initialization mode for this video unit, or a second value that indicates that all of the context states are to be initialized according to the default initialization mode for the video unit. The syntax element may be presented, for example, in an SPS, PPS, APS, slice header, entropy slice header, CU header, or the like.

If entropy decoding unit 80 determines that one or more context states should be initialized according to the adaptive initialization mode for a given video unit, entropy decoding unit 80 may be configured to decode a map, e.g., received from video encoder 20, that indicates, for a given video unit, the initialization status of each individual context, in terms of whether the default or adaptive initialization mode is used for each individual context. Entropy decoding unit 80 may decode the map on a per-video unit basis, based upon which context states are initialized according to the default initialization mode and the adaptive initialization mode. If none of the context states are initialized according to the adaptive initialization mode for a given video unit, e.g., as indicated by the value of the flag or other syntax element for the video unit, entropy decoding unit 80 need not attempt to receive and decode the map. The map may be presented, for example, in an SPS, PPS, APS, slice header, entropy slice header, CU header, or the like.

When entropy decoding unit 80 uses the adaptive initialization mode for a context state, entropy decoding unit 80 may, in some examples, explicitly receive the actual initial context state value used for entropy encoding from video encoder 20. In other examples, entropy decoding unit 80 may instead receive other information from video encoder 20, from which entropy decoding unit 80 may derive the initial context state value. Examples of signaling other information and deriving the initial context state value are described below with reference to FIGS. 6 and 7.

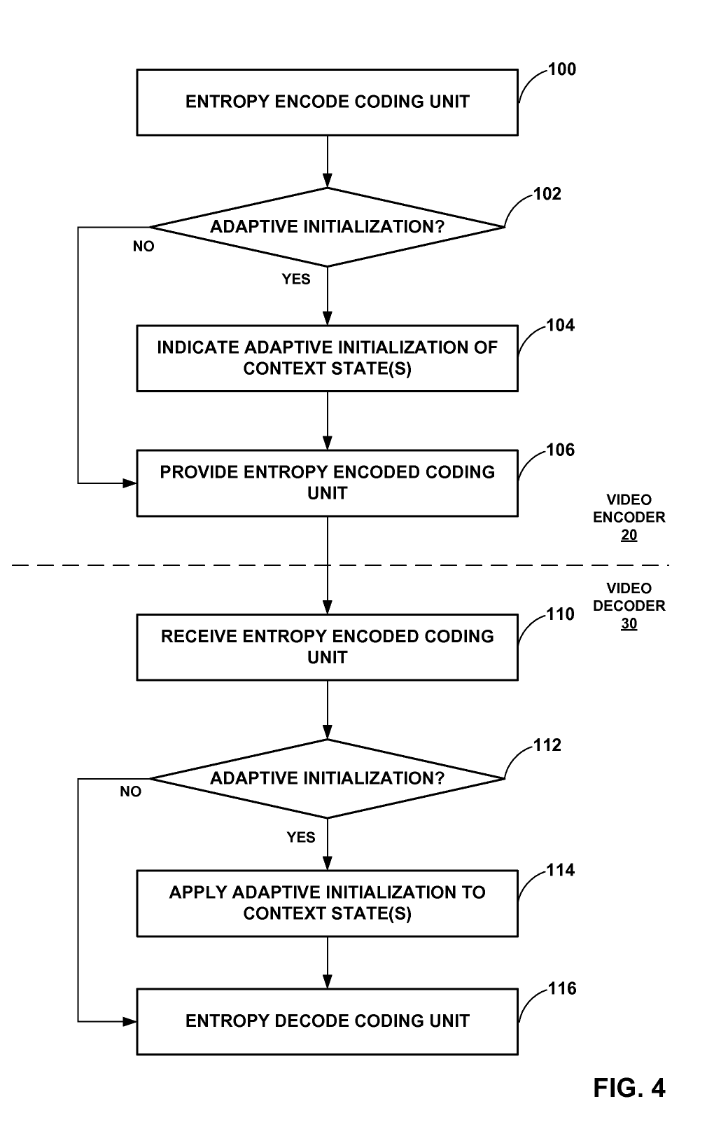

FIG. 4 is a flowchart illustrating an example method for adaptive initialization of context states for context adaptive entropy coding, consistent with the techniques of this disclosure. More particularly, FIG. 4 illustrates an example method by which video encoder 20 and video decoder 30 may adaptively initialize the states of one or more contexts for a particular video unit, e.g., frame or slice. Video encoder 20 and video decoder 30 may perform the method of FIG. 4 for each of a plurality of video units in a video sequence.

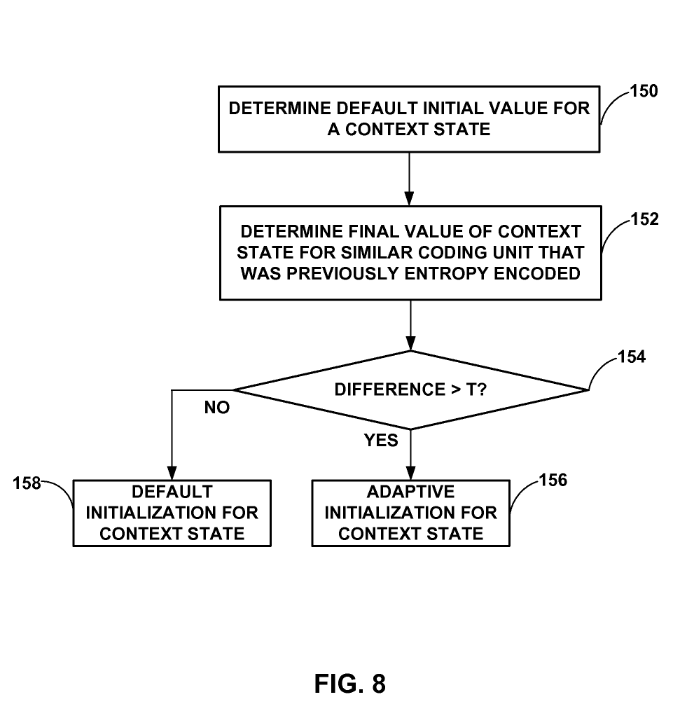

According to the example method of FIG. 4, video encoder 20 and, more particularly, entropy encoding unit 56 of video encoder 20, may entropy encode the video unit (100). As discussed above, entropy encoding unit 56 may utilize a CABAC or other context adaptive entropy coding process to entropy encode the video data of the video unit. During the entropy encoding of the video unit, entropy encoding unit 56 may determine, for each of a plurality of contexts, whether an adaptive initialization mode or default initialization mode should be used to initialize the context state for the video unit (102). Techniques for determining whether an adaptive initialization mode or default initialization mode should be used to initialize a context state are described in greater detail with respect to FIG. 8.

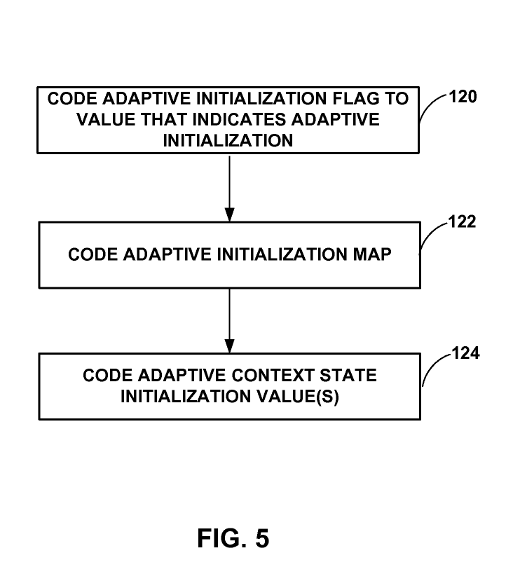

If entropy encoding unit 56 uses the adaptive initialization mode to initialize one or more context states, entropy encoding unit 56 may indicate the adaptive initialization of the one or more context states, e.g., to video decoder 30, in the bitstream (104). Although the states of some contexts may be adaptively initialized, other contexts may be initialized according to a default mode. Techniques for indicating the adaptive initialization are described in greater detail with reference to FIGS. 5-7. After entropy encoding of the video unit (100), entropy encoding unit 56 may, whether or not the adaptive initialization mode was used for any contexts for the video unit (102), provide the entropy encoded video unit, e.g., place the entropy coded video unit in the bitstream for receipt by video decoder 30 (106).

Video decoder 30 and, more particularly, entropy decoding unit 80 of video decoder 30, receives the entropy encoded video unit (110). Entropy decoding unit 80 may determine whether the adaptive initialization mode is to be used to initialize the state of any of the plurality of contexts for entropy decoding the video unit (112). Entropy decoding unit 80 may determine whether the adaptive initialization mode is to be used based on information included in the bitstream by video encoder 20. Entropy decoding unit 80 may also receive information in the bitstream regarding the initial state value of a context according to the adaptive initialization mode from video encoder 20. Techniques for signaling whether an adaptive initialization mode is used, and what initial state value should be given to a context according to the adaptive initialization mode, are described in greater detail below with respect to FIGS. 5-7.

If the adaptive initialization mode is to be used to initialize one or more context states (112), entropy decoding unit 80 applies the adaptive initialization mode to initialize those context states (114). If the adaptive initialization mode is not to be used to initialize any context states, or for context states not initialized according to the adaptive initialization mode when some context states are initialized according to the adaptive initialization mode, entropy decoding unit 80 applies the default initialization mode to initialize the context states. In any event, when the context states are initialized, e.g., via the adaptive or default initialization mode, entropy decoding unit 80 entropy decodes the video unit according to the initialized context states (116).

FIG. 5 is a flowchart illustrating an example method for adaptive initialization of context states for context adaptive entropy coding, consistent with the techniques of this disclosure. More particularly, FIG. 5 illustrates an example method that may be performed by video encoder 20 or video decoder 30 and, more particularly, entropy encoding unit 56 or entropy decoding unit 80, to identify whether an adaptive initialization mode is used to initialize one or more context states for a particular video unit. The example method of FIG. 5 may generally correspond to one example technique for indicating, e.g., to video decoder 30, adaptive initialization of context states by video encoder 20 (104 of FIG. 4). The example method of FIG. 5 may also generally correspond to one example technique for determining whether and how to adaptively initialize context states by a video decoder 30 based on information from video encoder 20 (112 of FIG. 4).

According to the example method of FIG. 5, an entropy coding unit (e.g., entropy encoding unit 56 or entropy decoding unit 80) may code (encode or decode) an adaptive initialization flag to a value that indicates that one or more of a plurality of context states are to be adaptively initialized, e.g., by video decoder 30 (120). The adaptive initialization flag may be an example of a syntax element, wherein coding a first value of the syntax element indicates that one or more of a plurality of context states are initialized using an adaptive initialization mode, and coding a second value of the syntax element indicates that each of the plurality of context states is initialized using a default initialization mode for the video unit. In some examples, the flag may be a single bit, where the first value is 1 (or 0) and the second value is 0 (or 1). The flag may be presented, for example, in an SPS, PPS, APS, slice header, entropy slice header, CU header, or the like. The value of the flag may be changed on a per-sequence, per-frame, per-slice, per-entropy slice, or per-coding unit basis, or the like.

In one example, at the beginning of each video unit, e.g., slice, entropy encoding unit 56 may include a flag referred to as “adaptive initialization flag” in the encoded bitstream. If adaptive_initialization_flag=0, entropy decoding unit 80 does not use the adaptive initialization mode to initialize any of the context states for the video unit. Instead, entropy decoding unit 80 uses the default initialization mode to initialize all context states. The default initialization mode may, as described above, be as specified the H.264/AVC standard or certain drafts of the HEVC standard, e.g., where the initial value of a context state is determined according to the following formula:

initial state=m*QP/16+n. EQ. (1)

The default initialization mode is known to both entropy encoding unit 56 and entropy decoding unit 80. For the default initialization mode, entropy encoding unit 56 may provide values of m and n to entropy decoding unit 80. For the default initialization mode, entropy decoding unit 80 may apply the signaled values of m and n in the equation above to determine the default initial state value for a context.

Coding adaptive_initialization_flag=1 is an example of coding an adaptive initialization flag to a value that indicates adaptive initialization (120). According to the example method of FIG. 5, when the adaptive initialization flag is coded to a value that indicates adaptive initialization, an entropy coding unit may code an adaptive initialization map (122). The adaptive initialization map may indicate which contexts should have context states initialized using the adaptive initialization mode, and which context states should be initialized using the default initialization mode.

In some examples, all context states may be initialized according to the adaptive initialization mode. In such examples, an adaptive initialization map may not be necessary. In such example, only a flag indicating application of the adaptive initialization mode may be signaled.

In some examples, if there are N contexts for the current video unit (e.g., N=369 for a slice in HEVC), an adaptive initialization map (CtxMap) may be a binary map of size Nx1, with the i^{th} entry CtxMap(i) corresponding to the i^{th} context, Ctx(i). In such examples, if entropy encoding unit 56 encodes CtxMap(i)=0, entropy decoding unit 80 derives the initial state value for the context, Ctx(i), using the default initialization mode. If entropy encoding unit 56 encodes CtxMap(i)=1, entropy decoding unit 80 uses the adaptive initialization mode to determine the initial state value for the context Ctx (i).

Any of a variety of techniques may be used to code CtxMap. In one example, CtxMap may be flag coded, e.g., every entry in the map is sequentially coded using binary values (0 or 1) of CtxMap(0), CtxMap(1), . . . CtxMap(N-1). Flag coding is straightforward, but may not be very efficient when there are a large number of consecutive values “1” or “0” in the map.

In another example, an entropy coding unit may run-level code CtxMap. For run-level coding, one of the binary values (0 or 1) is defined as the most-probable-value (MPS). As an example, if N=14 and CtxMap has values ‘00001011001000’, run-level coding with 0 as the MPS may be as follows:

(1) Before the first ‘1’, there are 4 consecutive ‘0’s, so the entropy coding unit codes run=4 to indicate that there are ‘0000’ followed by a ‘1’;

(2) After that, there is only one ‘0’ before the next ‘1’, so the entropy coding unit codes run=1;

(3) There is no ‘0’ between the current ‘1’ and the next ‘1’, so the entropy coding unit codes run=0;

(4) There are two consecutive ‘0's before next ‘1’, so the entropy coding unit codes run=2;

(5) There are three consecutive ‘0's before we reach the end of the string (or CtxMap), so the entropy coding unit codes run=3.

Compared to flag coding the example CtxMap with N=14, for which the full fourteen elements would be signaled, run-level coding only requires signaling five syntax (“run”) values for the example CtxMap. Although 0 is defined as the MPS in the above example, 1 may be the MPS for other examples. Run-level coding may be more efficient than flag coding, e.g., require less signaling in the bitstream, and the efficiency may be greater for larger maps and/or maps with longer runs of the MPS.

Accordingly, an entropy coding unit may run level code an adaptive initialization map. An entropy coding unit may, additionally or alternatively, code an adaptive initialization map using other coding methods. Examples of other coding methods include Unary code, Exponential-Golomb codes, fixed-length-code, and Rice-Golomb codes.

According to the example method of FIG. 5, when the adaptive initialization flag is coded to a value that indicates adaptive initialization, an entropy coding unit may also code adaptive context state initialization values for the contexts to be adaptively initialized (124). In some examples, entropy encoding unit 56 may directly signal the new initial state value for a given context, i.e., signal the new initial state value state_new(i), for the context Ctx(i), in the encoded bitstream. In such examples, the entropy decoder unit 80 obtains the initial state value of each adaptively initialized context based on the value state_new(i) signaled in the bitstream for context Ctx(i). In other examples, such as those described below with respect to FIGS. 6 and 7, entropy encoder unit 56 may encode other information in the bitstream that can be used by entropy decoder unit 80 to derive the initial context state values.

FIG. 6 is a flowchart illustrating an example method for deriving an initial value for a context state from information signaled from an encoder to a decoder in accordance with an adaptive initialization mode. In some examples, rather than the actual initial state value, state_new(i), for a context, Ctx(i), entropy encoder unit 56 may transmit, in the encoded bitstream, a quantization index of the new initial state, Qidx_state_new(i). Transmission of Qidx_state_new(i) instead of state_new(i) may be more efficient, e.g., in terms of requiring fewer bits in the bitstream.

In such examples, according to the method of FIG. 6, entropy decoder unit 80 may receive the quantization index, Qidx_state_new(i), for the particular context, Ctx(i) in the bitstream (130). Entropy decoder unit 80 may then derive the initial state value, state_new(i), of the context, Ctx(i) as a function of the quantization index, Qidx_state_new(i) (132). For example, entropy decoding unit 80 may derive the initial state value, state_new(i), by multiplying the quantization index, Qidx_state_new(i), with a quantization step size, Qstep, according to one of the following equations:

state_new(i)=Qstep*Qidx_state_new(i). Eq. (2)

state_new(i)=Qstep*Qidx_state_new(i)+offset. Eq. (3)

For each video unit, entropy encoding unit 56 may transmit one or more quantization index values, Qidx_state_new(i), e.g., for each context, Ctx(i), for which the adaptive initialization mode is used to initialize the state of the context. In this manner, the initial state value of the context, state_new(i), may be adaptively determined in a per-video unit basis. The quantization step, Qstep, and the offset may be predetermined values, or may be signaled from entropy encoding unit 56 to entropy decoding unit 80 less frequently than a per-video unit basis.

FIG. 7 is a flowchart illustrating another example method for deriving an initial state value for a context from information signaled from an encoder to a decoder in accordance with an adaptive initialization mode. In some examples, rather than the actual initial state value, state_new(i), for a context, Ctx(i), entropy encoder unit 56 may transmit, in the encoded bitstream, a differential state state_new_diff(i) to the decoder in the encoded bitstream. Transmission of state_new_diff(i) instead of state_new(i) may be more efficient, e.g., in terms of requiring fewer bits in the bitstream.

In such examples, according to the example method of FIG. 7, entropy decoder unit 80 may receive the differential value, state_new_diff(i) (140). Entropy decoder unit 80 may also derive a default initial state value, state_{—}0(i), for the context, Ctx(i), using the default initialization mode (e.g., state_{—}0(i)=m*QP/16+n) (142). Entropy decoding unit 80 may then apply, e.g., add, the received differential value to the default initial context state derived according to the default initialization mode (144). In some examples, the application of the received differential value to the derived default value may be according to the following equation:

state_new(i)=state_new_diff(i)+state_{—}0(i). Eq. (4)

Accordingly, in the example of FIG. 7, the differential value, state_new_diff(i), may represent a difference between the initial state value of the context according to the default initialization mode, state_{—}0(i), and the desired initial state value of the context according to the adaptive initialization mode, state_new(i).

In some examples, entropy encoder unit 56 may transmit a quantized version of the differential value, Qidx_state_new_diff(i). In such examples, entropy decoder unit 80 may perform inverse quantization to determine the differential value, state_new_diff(i). For example, entropy decoder unit 80 may determine the differential value as follows:

state_new_diff(i)=Qidx_state_new_diff(i)*Qstep+offset Eq. (5)

Entropy decoder unit 80 may then derive the desired initial state for the context according to the adaptive initialization mode based on the default value and differential value, as described above (e.g., Eq. (4)). Any of the information discussed herein as being included in a bitstream to facilitate adaptive initialization, e.g., state_new(i), Qidx_state_new(i), state_new_diff(i), or Qidx_state_new_diff(i), may be further coded using, as examples, Unary codes, Exponential-Golomb codes, fixed-length-code, Rice-Golomb codes, or other coding techniques.

FIG. 8 is a flowchart illustrating an example method for an encoder to determine whether to use the adaptive or default initialization mode to initialize a particular context state for a given video unit. According to the example of FIG. 8, entropy encoding unit 56 determines an initial value of the context state, state_{—}0(i), for a particular context, Ctx(i) using the default initialization mode (e.g., state_{—}0(i)=m*QP/16+n) (150). Entropy encoding unit 56 further determines, for the context, Ctx(i), a final state value of the context, i.e., the final probability value, that was produced during entropy encoding of a previous video unit, e.g., a previous slice, frame, or coding unit (152). Entropy encoding unit 56 may select a previously-entropy encoded video unit from which to take the final state value of the context by selecting a previously-entropy encoded video unit that is, in at least some respects, the same or substantially similar to the current video unit. For example, entropy encoding unit 56 may select a previously entropy encoded video unit which had the same or substantially similar QP and/or slice type as the current video unit.

The final state value of the context during encoding of the previous video unit may more closely represent the probability of the context for the current video unit. In general, coding efficiency may be greater if the initial state of the context is closer to the final probability of the context. Accordingly, if the default initial state of the context for the current video unit is not adequately similar to the final state of the context in the previous video unit, it may be desirable to provide an adaptive initial state of the context for the current video unit that is closer to, or the same as, the final value for the previous video unit to improve coding efficiency.

Entropy encoding unit 56 may determine a difference between the final state value of the context, Ctx(i), for the previously entropy encoded video unit, and the default initial state value, state 0(i), for the context, Ctx(i). Entropy encoding unit 56 may compare the determined difference, e.g., the absolute value of the difference, to a threshold, T (154). If the difference is greater than the threshold, T, entropy encoding unit 56 may use the adaptive initialization mode to initialize the state for the context, Ctx(i) for the current video unit (156). The adaptive initial state for the current video unit may be the same as final state for the previous video unit, or closer to the final state value for the previous coding unit than the default initial state value. Otherwise, entropy encoding unit 56 may use the default initialization mode to initialize the state value for the context, Ctx(i) for the current video unit, e.g., use the determined default initial state value, state_{—}0(i) (158).

In order to use the adaptive initialization mode to initialize the state value for the context, Ctx(i), entropy encoding unit 56 may determine an adaptive initial state value, state_new(i), for the context, Ctx(i). In some examples, entropy encoding unit 56 determines the adaptive initial state value for the context for the current video unit to be the final state value for the context during entropy encoding of the previous video unit, or based on the final state value. In some examples, entropy encoding unit 56 determines the adaptive initial state value for the context for the current video unit based on modeling or other analysis of the video data, or based on other criteria.

Entropy encoding unit 56 may place information in the bitstream to indicate to a video decoder 30 that the adaptive initialization mode is to be used to initialize the particular context, Ctx(i), for this video unit, and to indicate the adaptive initial state value for the context, e.g., as described above with respect to FIGS. 4-7. For example, entropy encoding unit 56 may encode a flag to indicate that the adaptive initialization mode is used during the video unit, and a map to indicate that the adaptive initialization mode is used for the particular context, Ctx(i). As discussed above, the map may comprise a plurality of values, where each value corresponds to one of the plurality of contexts, and indicates whether the initial state of the corresponding context is initialized according to the default initialization mode or the adaptive initialization mode. Entropy encoding unit 56 may also directly signal the adaptive initial state value, state_new(i), for the context, Ctx(i), to the video decoder 30, or may signal other information from which the video decoder may derive the adaptive initial state value, e.g., as described above with respect to FIGS. 6 and 7.

As discussed above, in some examples, the adaptive initial state value, state_new(i), of a context, Ctx(i) is the final state value of the context in a previously-encoded video unit. In such examples, referring to FIG. 8, entropy encoding unit 56 may only transmit the adaptive initial state value, state_new(i), when the difference between state_new(i) and the default initial state value, state_{—}0(i), is larger than a threshold, T (154). The difference may be calculated as follows:

state_new_diff(i)=state_new(i)−state_{—}0(i). Eq. (6)

In some examples, the difference, state_new_diff(i), may be the differential value that entropy encoding unit 56 signals to video decoder 30, which the video decoder may then use to derive the adaptive initialization state value from the default initialization state value, e.g., according to the example method of FIG. 7. Since the entropy encoding unit 56 will not, in such examples, transmit state_new_diff(i) when abs(state_new_diff(i))<T, both the entropy encoding unit 56 and entropy decoding unit 80 may apply a predetermined calculation to state new diff(i) in order to allow state_new_diff(i) to be coded more efficiently. For example, the entropy coding units may calculate:

offset=sign(state_new_diff(i))*abs((state_new_diff(i))−T). Eq. (7)

Based on this calculation, the range of abs(offset) starts from 0. The entropy coding units may then code offset by mapping the value of offset to a codeword as follows:

uiCodeIndex=sign(offset)?abs(offset)*2:abs(offset)*2+1. Eq. (8)

In other words, entropy coding unit 56 may determine state_new_diff(i) as described above with respect to FIGS. 7 and 8, calculate the offset as illustrated in equation 7, and then encode the offset as illustrated in equation 8. Entropy decoding unit 80 may then decode the offset according to equation 8, and calculate state_new_diff(i) from the offset based on equation 7. Entropy decoding unit 80 may then determine the adaptive initial state, state_new(i) based on state_new_diff(i), as described above with respect to FIG. 7. Calculating and coding the offset as illustrated with respect to equations 7 and 8 may improve coding efficiency relative to signaling state_new_diff(i) directly.

In some examples, the range of offset is not symmetric. For example, assuming that the range of state is 0-126, if state_{—}0(i)=5, then the offset can only be −5 to 121 (assuming T=0). The entropy coding units may use this asymmetric property for even more efficient coding of the offset, which may be determined according to equation 7, as discussed above. Example pseudocode that may be used by the entropy coding units to more efficiently code asymmetric values offset is as follows:

if abs(offset)<=5,

uiCodeIndex=sign(offset)?abs(offset)*2:abs(offset)*2+1;

else,

uiCodeIndex=(offset)−5+(5*2+1);

According to the techniques described herein entropy coding units selectively, on a per-video unit basis, initialize context states according to the adaptive initialization mode of the default initialization mode. In some examples, the relevant video unit is a slice, and the entropy coding units may selectively, on a per-slice unit basis, initialize context states according to the adaptive initialization mode of the default initialization mode. In such examples, the syntax elements associated with the techniques described herein, e.g., a flag, a map, adaptive initial state values, quantization indexes, or differential values, may be coded in slice headers. In examples in which the entropy coding units selectively apply either the adaptive initialization mode or the default initialization mode on a less frequent basis, e.g., per frame, the syntax elements may instead be encoded on a less frequent basis, e.g., in a picture parameter set (PPS), sequence parameter set (SPS) and/or an adaptation parameter set (APS).

The described techniques for adaptive initialization of context state values for context adaptive entropy coding has been generally described as being used for any of the possible contexts. In other examples, the described techniques may be used for contexts related to certain syntax, e.g., syntax for selected color components (luma/chroma), selected block size, selected transform size, syntax for motion information, or syntax for transform coefficients information. In some examples, adaptive initialization can be applied selectively for different types of syntax, e.g., such that adaptive initialization of context states may be used for some types of syntax elements but not others.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method for context adaptive entropy coding a video unit, the method comprising:
coding a syntax element, wherein a first value of the syntax element indicates that one or more of a plurality of context states are initialized using an adaptive initialization mode for the video unit, and a second value of the syntax element indicates that each of the plurality of context states is initialized using a default initialization mode for the video unit;
applying the adaptive initialization mode to initialize one or more of the context states when the syntax element is coded with the first value;
applying the default initialization mode to initialize all of the contexts when the syntax element is coded with the second value; and
context adaptive entropy coding the video unit according to the initialized context states.

2. The method of claim 1, wherein the video unit comprises one of a frame, a slice, an entropy slice, a coding unit, or a tile.

3. The method of claim 1, wherein coding the syntax element comprises coding the syntax element in one of a slice header, a coding unit header, an entropy slice header, a picture parameter set (PPS), a sequence parameter set (SPS), or an adaptation parameter set (APS).

4. The method of claim 1, wherein coding the syntax element comprises coding a one-bit flag.

5. The method of claim 1, wherein, when the syntax element has the first value for the video unit, the method further comprises:
coding a map comprising a plurality of values, each of the values of the map corresponding to a respective one of the plurality of context states and indicating whether the respective context state is initialized using the adaptive initialization mode or the default initialization mode for the video unit.

6. The method of claim 5, wherein coding the map comprises run-level coding the map.

7. The method of claim 1, wherein the default initialization mode comprises a mode of initializing context states specified for at least one of the High Efficiency Video Coding (HEVC) standard or the ITU-T standard.

8. The method of claim 1, wherein context adaptive entropy coding the video unit comprises context adaptive entropy decoding the video unit by a decoder, and wherein initializing one of the context states using the adaptive initialization mode for the video unit comprises initializing the context state with an initial value directly signaled from an encoder to the decoder for the video unit.

9. The method of claim 1, wherein context adaptive entropy coding the video unit comprises context adaptive entropy decoding the video unit by a decoder, and wherein initializing one of the context states using the adaptive initialization mode for the video unit comprises deriving, by the decoder, an initial value for the context state from information for the context state signaled from an encoder to the decoder for the video unit.

10. The method of claim 9, wherein the information for the context state comprises a quantization index for the context state, and wherein deriving, by the decoder, the initial value for the context state comprises deriving the initial value based on the quantization index.

11. The method of claim 9, wherein the information for the context state comprises a differential value, and wherein deriving, by the decoder, the initial value for the context state comprises:
determining, a default initial value of the context state according to the default initialization mode; and
applying the differential value to the default initial value to generate the initial value.

12. The method of claim 11, wherein the video unit comprises a current video unit, the method further comprising:
determining by the encoder, a final value of the context state for a previously coded video unit; and
determining, by the encoder, the differential value as a difference between the final value of the context state for the previously coded video unit and the default initial value of the context state for the current video unit.

13. The method of claim 12, further comprising selecting, by the encoder, the previously coded video unit based on the previously coded video unit having substantially the same quantization parameter and slice type as the current video unit.

14. The method of claim 11, further comprising, by the encoder:
comparing the differential value to a threshold value;
initializing the context state using the adaptive initialization mode when the differential value is greater than the threshold value; and
initializing the context state using the default initialization mode when the differential value is less than the threshold value.

15. The method of claim 1,
wherein coding the syntax element comprises decoding the syntax element,
wherein, when the syntax element has the first value for the video unit, the method further comprises decoding a map comprising a plurality of values, each of the values of the map corresponding to a respective one of the plurality of context states and indicating whether the respective context state is initialized using the adaptive initialization mode or the default initialization mode for the video unit,
wherein initializing one of the context states using the adaptive initialization mode for the video unit comprises deriving an initial value for the context state from information for the context state received from an encoder for the video unit, and
wherein context adaptive entropy coding the video unit of video data according to the initialized context states comprises context adaptive entropy decoding the video unit according to the initialized context states.

16. The method of claim 1, wherein context adaptive entropy coding the video unit comprises context adaptive binary arithmetic coding (CABAC) the video unit.

17. The method of claim 1, wherein coding the syntax element comprises encoding the syntax element, and context adaptive entropy coding the video unit comprises context adaptive entropy encoding the video unit.

18. The method of claim 1, wherein coding the syntax element comprises decoding the syntax element, and context adaptive entropy coding the video unit comprises context adaptive entropy decoding the video unit.

19. An apparatus for context adaptive entropy coding a video unit, the apparatus comprising a coder configured to:
code a syntax element, wherein a first value of the syntax element indicates that one or more of a plurality of context states are initialized using an adaptive initialization mode for the video unit, and a second value of the syntax element indicates that each of the plurality of context states is initialized using a default initialization mode for the video unit;
apply the adaptive initialization mode to initialize one or more of the context states when the syntax element is coded with the first value;
apply the default initialization mode to initialize all of the contexts when the syntax element is coded with the second value; and
context adaptive entropy code the video unit according to the initialized context states.

20. The apparatus of claim 19, wherein the video unit comprises one of a frame, a slice, an entropy slice, a coding unit, or a tile.

21. The apparatus of claim 19, wherein the coder is configured to code the syntax element in one of a slice header, an entropy slice header, a coding unit header, a picture parameter set (PPS), a sequence parameter set (SPS), or an adaptation parameter set (APS).

22. The apparatus of claim 19, wherein the syntax element comprises a one-bit flag.

23. The apparatus of claim 19, wherein, when the syntax element has the first value for the video unit, the coder is further configured to:
code a map comprising a plurality of values, each of the values of the map corresponding to a respective one of the plurality of context states and indicating whether the respective context state is initialized using the adaptive initialization mode or the default initialization mode for the video unit.

24. The apparatus of claim 23, wherein the coder run-level codes the map.

25. The apparatus of claim 19, wherein the default initialization mode comprises a mode of initializing context states specified for at least one of the High Efficiency Video Coding (HEVC) standard or the ITU-T standard.

26. The apparatus of claim 19, wherein the coder comprises a decoder, and wherein, according to the adaptive initialization mode, the decoder initializes one of the context states with an initial value directly signaled from an encoder to the decoder for the video unit.

27. The apparatus of claim 19, wherein the coder comprises a decoder, and wherein, according to the adaptive initialization mode, the decoder derives an initial value for the context state from information for the context state signaled from an encoder for the video unit.

28. The apparatus of claim 27, wherein the information for the context state comprises a quantization index for the context state, and wherein the decoder derives the initial value based on the quantization index.

29. The apparatus of claim 27, wherein the information for the context state comprises a differential value, and wherein the decoder is further configured to:
determine a default initial value of the context state according to the default initialization mode; and
applying the differential value to the default initial value to generate the initial value according to the adaptive initialization mode.

30. The apparatus of claim 19,
wherein the coder comprises an encoder and the video unit comprises a current video unit,
wherein, according to the adaptive initialization mode, the encoder:
determines a default initial value of the context state for the current video unit according to the default initialization mode;
determines a differential value as a difference between a final value of the context state for a previously encoded video unit and the default initial value of the context state for the current video unit; and
signal the differential value to a decoder,
wherein decoder derives an initial value for the context state for the current video unit according to the adaptive initialization mode by at least determining the default initial value of the context state according to the default initialization mode and applying the differential value to the default initial value.

31. The apparatus of claim 30, wherein the previously encoded video unit has substantially the same quantization parameter and slice type as the current video unit.

32. The apparatus of claim 30, wherein the encoder is further configured to:
compare the differential value to a threshold value;
initialize the context state using the adaptive initialization mode when the differential value is greater than the threshold value; and
initialize the context state using the default initialization mode when the differential value is less than the threshold value.

33. The apparatus of claim 19, wherein the coder comprises a video decoder configured to:
decode the syntax element;
when the syntax element has the first value for the video unit, decode a map comprising a plurality of values, each of the values of the map corresponding to a respective one of the plurality of context states and indicating whether the respective context state is initialized using the adaptive initialization mode or the default initialization mode for the video unit,
for each of the context states initialized using the adaptive initialization mode for the video unit, derive an initial value for the context state from information for the context state received from an encoder, and
context adaptive entropy decode the video unit of video data according to the initialized context states.

34. The apparatus of claim 19, wherein the coder is configured to context adaptive binary arithmetic code (CABAC) the video unit.

35. The apparatus of claim 19, wherein the coder comprises an encoder.

36. The apparatus of claim 19, wherein the coder comprises a decoder.

37. The apparatus of claim 19, wherein the apparatus comprises at least one of:
an integrated circuit;
a microprocessor; and
a wireless communication device that includes the coder.

38. An apparatus for context adaptive entropy coding a video unit, the apparatus comprising:
means for coding a syntax element, wherein a first value of the syntax element indicates that one or more of a plurality of context states are initialized using an adaptive initialization mode for the video unit, and a second value of the syntax element indicates that each of the plurality of context states is initialized using a default initialization mode for the video unit;
means for applying the adaptive initialization mode to initialize one or more of the context states when the syntax element is coded with the first value;
means for applying the default initialization mode to initialize all of the contexts when the syntax element is coded with the second value; and
means for context adaptive entropy coding the video unit according to the initialized context states.

39. The apparatus of claim 38, wherein the means for coding the syntax element comprises means for coding a one-bit flag.

40. The apparatus of claim 38, wherein the apparatus further comprises:
means for, when the syntax element has the first value for the video unit, coding a map comprising a plurality of values, each of the values of the map corresponding to a respective one of the plurality of context states and indicating whether the respective context state is initialized using the adaptive initialization mode or the default initialization mode for the video unit.

41. The apparatus of claim 40, wherein the means for coding the map comprises means for run-level coding the map.

42. The apparatus of claim 38, wherein the means for coding comprises means for decoding, and wherein the means for initializing one of the context states using the adaptive initialization mode for the video unit comprises means for deriving an initial value for the context state from information for the context state signaled from an encoder for the video unit.

43. The apparatus of claim 42, wherein the information for the context state comprises a quantization index for the context state, and wherein the means for deriving the initial value for the context state comprises means for deriving the initial value based on the quantization index.

44. The apparatus of claim 42, wherein the information for the context state comprises a differential value, and wherein the means for deriving the initial value for the context state comprises:
means for determining a default initial value of the context state according to the default initialization mode; and
means for applying the differential value to the default initial value to generate the initial value.

45. The apparatus of claim 38, wherein the means for coding comprises means for encoding, and the video unit comprises a current video unit, the apparatus further comprising:
means for determining a default initial value of the context state for the current video unit according to the default initialization mode;
means for determining a differential value as a difference between a final value of the context state for a previously encoded video unit and the default initial value of the context state for the current video unit; and
means for signaling the differential value to a decoder,
wherein the decoder derives an initial value for the context state for the current video unit according to the adaptive initialization mode by at least determining the default initial value of the context state according to the default initialization mode and applying the differential value to the default initial value.

46. The apparatus of claim 45, further comprising:
means for comparing the differential value to a threshold value;
means for initializing the context state using the adaptive initialization mode when the differential value is greater than the threshold value; and
means for initializing the context state using the default initialization mode when the differential value is less than the threshold value.

47. The apparatus of claim 38,
wherein the means for coding the syntax element comprises means for decoding the syntax element,
wherein the apparatus further comprises means for, when the syntax element has the first value for the video unit, decoding a map comprising a plurality of values, each of the values of the map corresponding to a respective one of the plurality of context states and indicating whether the respective context state is initialized using the adaptive initialization mode or the default initialization mode for the video unit,
wherein the means for initializing the context states comprises means for, when initializing one of the context states using the adaptive initialization mode, deriving an initial value for the context state from information for the context state received from an encoder for the video unit, and
wherein the means for context adaptive entropy coding the video unit according to the initialized context states comprises means for context adaptive entropy decoding the video unit according to the initialized context states.

48. A computer-readable storage medium having stored thereon instructions that upon execution cause one or more processors to perform context adaptive entropy coding of a video unit, wherein the instructions cause the one or more processors to:
code a syntax element, wherein a first value of the syntax element indicates that one or more of a plurality of context states are initialized using an adaptive initialization mode for the video unit, and a second value of the syntax element indicates that each of the plurality of context states is initialized using a default initialization mode for the video unit;
apply the adaptive initialization mode to initialize one or more of the context states when the syntax element is coded with the first value;
apply the default initialization mode to initialize all of the contexts when the syntax element is coded with the second value; and
context adaptive entropy code the video unit according to the initialized context states.

49. The computer-readable storage medium of claim 48, wherein the instructions that cause the one more or more processor to code the syntax element comprise instructions that cause the one or more processors to code a one-bit flag.

50. The computer-readable storage medium of claim 48, further comprising instructions that cause the one or more processors to:
when the syntax element has the first value for the video unit, code a map comprising a plurality of values, each of the values of the map corresponding to a respective one of the plurality of context states and indicating whether the respective context state is initialized using the adaptive initialization mode or the default initialization mode for the video unit.

51. The computer-readable storage medium of claim 50, wherein the instructions that cause the one more or more processors to code the map comprise instructions that cause the one more or more processors to run-level code the map.

52. The computer-readable storage medium of claim 48, wherein the instructions that cause the one or more processors to code comprise instructions that cause the one or more processors to decode, the medium further comprising instructions that cause the one or more processors to, when initializing one of the context states using the adaptive initialization mode for the video unit, derive an initial value for the context state from information for the context state signaled from an encoder for the video unit.

53. The computer-readable storage medium of claim 52, wherein the information for the context state comprises a quantization index for the context state, and wherein the instructions that cause the one more or more processors to derive the initial value for the context state comprise instructions that cause the one more or more processors to derive the initial value based on the quantization index.

54. The computer-readable storage medium of claim 52, wherein the information for the context state comprises a differential value, and wherein the instructions that cause the one more or more processors to deriving the initial value for the context state comprise instructions that cause the one more or more processors to:
determine a default initial value of the context state according to the default initialization mode; and
apply the differential value to the default initial value to generate the initial value.

55. The computer-readable storage medium of claim 48, wherein the instructions that cause the one or more processors to code comprise instructions that cause the one or more processors to decode, and the video unit comprises a current video unit, the medium further comprising instructions that cause the one more or more processors to:
determine a default initial value of the context state for the current video unit according to the default initialization mode;
determine a differential value as a difference between a final value of the context state for a previously encoded video unit and the default initial value of the context state for the current video unit; and
signal the differential value to a decoder,
wherein the decoder derives an initial value for the context state for the current video unit according to the adaptive initialization mode by at least determining the default initial value of the context state according to the default initialization mode and applying the differential value to the default initial value.

56. The computer-readable storage medium of claim 55, further comprising instructions that cause the one or more processors to:
compare the differential value to a threshold value;
initialize the context state using the adaptive initialization mode when the differential value is greater than the threshold value; and
initialize the context state using the default initialization mode when the differential value is less than the threshold value.

57. The computer-readable storage medium of claim 48,
wherein the instructions that cause the one more or more processors to code the syntax element comprise instructions that cause the one more or more processors to decode the syntax element,
wherein the medium further comprises instructions that, when the syntax element has the first value for the video unit, cause the one or more processors to decode a map comprising a plurality of values, each of the values of the map corresponding to a respective one of the plurality of context states and indicating whether the respective context state is initialized using the adaptive initialization mode or the default initialization mode for the video unit,
wherein the instructions that cause the one more or more processors to initialize the context states comprises instructions that cause the one more or more processors to, when initializing one of the context states using the adaptive initialization mode, derive an initial value for the context state from information for the context state received from an encoder for the video unit, and
wherein the instructions that cause the one more or more processors to context adaptive entropy code the video unit according to the initialized context states comprise instructions that cause the one more or more processors to context adaptive entropy decoding the video unit according to the initialized context states.
